(19) United States
(12) Patent Application Publication
(10) Pub. No.: US 2014/0374279 A1
(43) Pub. Date: Dec. 25, 2014

(54) Transport and Storage Device with Folding Splatter Guard

(71) Applicants: Adam John Bechtel, Lafayette, IN (US); Brandon Scott Bechtel, Lafayette, IN (US)

(72) Inventors: Adam John Bechtel, Lafayette, IN (US); Brandon Scott Bechtel, Lafayette, IN (US)

(21) Appl. No.: 14/307,634

(22) Filed: Jun. 18, 2014

Related U.S. Application Data
(60) Provisional application No. 61/957,091, filed on Jun. 24, 2013.

(51) Int. Cl. B44D 3/04

(52) U.S. Cl. CPC B44D 3/04
USPC 206/1.7

(57) ABSTRACT

A device to store and transport materials and tools, for example, paint and painting implements, to and from a worksite while shielding the floor, floor covering, table, table covering, or other supporting surface from material splatter. The sides of the device serve as coating material splatter guards, acting as a protective tarp, when working yet are folding to serve as an integral part of the material and tool container when during transport and storage. The device has a capability of storing a coating medium. The device may also include a compartment and carrier to store and transport various tools required at a worksite. The folding splatter guard sides fold up to enclose the structure, enabling easy transport between worksites.

### CROSS REFERENCE TO RELATED APPLICATIONS

The present application claims priority under 35 USC 119 (e) (1) from U.S. Provisional Patent Application Ser. No. 61/957,091 filed on Jun. 24, 2013, entitled “Paint and tool transport and storage device with folding splatter guard sides, bottom, and top”, the entirety of which is incorporated herein by reference.

### STATEMENT REGARDING FEDERALLY SPONSORED RESEARCH OR DEVELOPMENT

Not Applicable

### REFERENCE TO A SEQUENCE LISTING, A TABLE, OR A COMPUTER PROGRAM LISTING COMPACT DISC APPENDIX

Not applicable

### BACKGROUND OF THE INVENTION

The present invention has application in the construction trades, specifically painting, staining, coatings, cleaning, treating, and other activities involving the application of liquids on surfaces for aesthetic or functional reasons.

Painter toolboxes, tool bibs and belts, and features sewn into clothing to hold painter's tools are known in the art. Carriers for materials and tools used for cleaning are also common.

Vertical tubular storage is taught by Mander in U.S. Pat. No. 3,643,812 where it is used to store a plurality of test tubes or other tubular containers; however, Mander did not extend his thinking to teach the application of a protective and integrated unfolding splatter guard to block spills or contamination. Instead, Mander is limited to a box like container containing dividers for holding tubular shaped objects in predetermined locations.

In U.S. Pat. No. 5,526,929, inventor Wei articulates a similar concept of predetermined cylindrical tool locations in a covered toolbox, teaching sockets for a mechanic's socket set with a lid to prevent loss of tools should the box tip over. Indeed, the invention enables the repeatable placement and transportability of necessary tools but does not address wet tools with a potential to contaminate, drip, splatter, or otherwise contact other tools or areas where such contamination is to be avoided.

Inventor Perkins was granted U.S. Pat. No. 4,303,158 on a toolbox containing predetermined tool storage locations with both a lid and a single folding sidewall. As was the case with other prior art, this invention did not adequately address the need to prevent drips or splattering from tools containing paint or coating material across a broader area. Instead, Perkins claims a fixed bottom wall and back wall, with sidewalls fixed as well. Only the front wall of a trapezoid shaped toolbox folds open. Moreover, the fold down sidewall was merely for the purpose of easing the access to a wider selection of tools when the box was placed on a table or stand. Perkins also fails to teach use of a folding cover material with the ability to absorb drips or splatters in order to prevent further contamination.

Returning to the other area of art where predetermined locations for carrying or storing tubular objects is found, inventor Qian and Li have been granted U.S. Pat. No. 8,215,480 for a Microtube Container and Carrier for Multiple Carriers. This invention teaches a box capable of holding a row of elongated vials with a lid designed to open as two clamshell halves, capable of covering the objects entirely when closed, and facilitating easy access to the carried objects when fully open. The invention is essentially a test tube rack in a box, where said box can be incorporated into yet another storage container with other identical boxes. Qian teaches simple detent mechanisms to snap the boxes closed. When the covers open, whether partially open or fully opened, there is a gap between any potential sidewall surfaces, which might otherwise catch an inadvertent drip or spill of coating material. This gap, permitting a leak of material down the side of the box and onto the surface it sits upon, would make the concept unsuitable as a solution, which might be considered to anticipate the present invention. The present invention includes a fully unfolding and continuous surface, which becomes a paint tarp equivalent and prevents any drips, spills, or splattering of materials from reaching the supporting surface or carpet where the present invention is placed.

Splatter guards, tarps, and drop cloths have been used for years to protect surfaces from unwanted paint and stain exposure. Within this art, various devices have been developed to combine the protective features of a drop cloth with the holding capability of a paint vessel.

In U.S. Pat. No. 4,846,100, inventor Montoya teaches a folding board with an integrated structure to stabilize a paint roller pan, but not designed to carry tools, and not securing the paint vessel in a manner to block lateral movement by using a second, receiving opening. Indeed, when a roller is moved within a nearly empty paint pan, movement of the pan can occur and Montoya addresses this problem to some extent, although the pan can still be moved with sufficient force or when slid backwards where there is no fixation cardboard present. The present invention includes a fixed opening to receive a paint container such as a paint roller well or trim cup for the purpose of carrying or storage, or, in an alternative embodiment, integrated paint containers permanently affixed or molded into the device. Professional paint wells for large rollers are sufficiently heavy that stabilizing them as taught by Montoya for small, light home use roller pans, is unnecessary and therefore not the object of the present invention. Montoya also claims his invention to be collapsible, not an object of the present invention. Additionally, Montoya intends the folding and collapsible splatter guard to become a disposal means for the wet paint roller pan. Again, none of these ideas inform, anticipate, or benefit the present invention. The Montoya patent does not teach a transportable splatter guard, useful for transportation and storage of the paint vessel, thus it does not provide the means to carry the pan from location to location along with other tools, which is described in the present invention.

Analogous to a splatter guard for a paint-rolling tray, U.S. Pat. No. 5,759,275 invented by Shostak teaches a splatter guard to snap onto an open paint can. Again, this invention fails to teach transportability and storage, also ignoring the need to carry tools along with paint or coating materials when moving from job site to job site. Likewise, inventor Romero also deals with spillage from a bucket, in the case of U.S. Pat. No. 6,815,036, teaching a protective guard underneath the bucket rather than placed around the top area of the bucket, as was the case with Shostak's art. Romero's stiff, tool holding, protective sheet and use of resilient elastic cords to attach to the bucket handle in order to facilitate the co-transport of hand tools carried in pockets on the stiff sheet, does not address the transport of wet paint tools or protection of the underlying floor or carpet if the tools carried have come into contact with wet paint.

Similarly, inventor Demitry teaches a paint mat which attaches to the bottom side of a paint bucket in U.S. Pat. No. 6,971,420. One embodiment includes a tab extending the circular mat to facilitate placement of a wet brush. Again, this patent is limited to mere shielding of a lower surface floor, carpet, countertop, or other surface from contamination with wet paint and Demitry's novelty in no way informs or anticipates the many features and elements in the present invention.

Rioux has invented a more elaborate collapsible paint tray carrier and paint spatter protector, granted as U.S. Pat. No. 4,325,323. This invention stabilizes a roller pan along a vertical wall while simultaneously protecting the baseboard and floor from drips or splattering. The main bar to practical commercialization of the Rioux art is its requirement for nearly constant movement as the painting of a wall proceeds. In contrast, the present invention protects a large area of central flooring or carpet, permitting the painter to walk to and from the walls using a roller without the added difficulty and risk involved moving the invention as each smaller section of wall is completed. Moreover, most drips of splatter occur at the paint storage receptacle during dipping and roll out and not along the wall, assuming the roll out is done correctly. As such, professional painters would find the Rioux art to be an encumbrance to completing their jobs, rather than a benefit.

U.S. Pat. No. 4,998,696 describes a paint can caddy invented by Desjardins which may fairly be described as being analogous to a large cup holder sized to fit a can of paint. Desjardins' invention may be clamped to a ladder, used to transport the pan, and has a lower compartment for tools. These elements noted, it does not do an effective job of shielding against roller drips or splatter; in fact, not even being capable of supporting roller type painting and coating essential for production painting work.

### BRIEF SUMMARY OF THE INVENTION

When painting at multiple job sites, time is often wasted prepping and cleaning up after a job in addition to carrying tools and materials to and from worksites. Without a device to pack up and carry tools and materials, the plurality of tools required for painting, cleaning, coating, or treating results in additional time being consumed transporting individual tools and materials to and from vehicles, or between work locations. In addition, wet brushes, rollers, and paint containers, which may have wet paint on their exteriors, are difficult to collect and carry at one time, and may contact walls, doorways, or other objects not intended to be painted. The result is often multiple trips to and from work vehicles, which consumes extra time and labor and the risk of extra cleanup to remove accidental paint smears in unwanted areas. An object of the present invention is to transport all tools and materials between locations efficiently by making only one trip. If those essential tools and materials can be placed in a carrier and sufficiently shielded to prevent paint transfer when bumping against walls, railings, and other objects in the pathway to the worksite, the entire process of changing work locations can be dramatically improved. Given that making multiple trips to transport tools to a job site is costly, and can even result in spots or splatters in unintended locations along the route, the present invention aims to combine the painter's tarp, paint vessel, and toolbox into one device which is light enough to be moved easily and safely, typically by a single worker.

Construction and maintenance painting of dwellings, offices, or other multi-room or multi-dwelling buildings typically requires transporting material and equipment between rooms, apartments, offices, and so forth. The same is true for coating, treating, cleaning, or painting any immovable object or structure. As such, the time and labor necessary to transport and deploy equipment moving from location to location is part of the total cost involved.

The object of the present invention is to reduce this labor cost while assuring that the necessary equipment and material is always present at the location where the work is being performed. Additional objects of the present invention include organizing the various tools required for the work and providing a convenient and cost effective means to transport the tools from location to location, reducing crew deployment time and the changeover time between work locations. Another object of the invention includes the ability to hold, transport, and store equipment that is “wet” or containing paint or coating material. The elements which facilitate this feature keep the material transferring to other tools or parts of the invention where it is not desired, also preventing spills, and finally, eliminating the need for cleaning between work locations. It is also an object of the present invention to reduce the cost of lost tools left behind when changing work site locations, and this object is met by including a compartment where all tools are to be returned after use.

Another object of the present invention is to facilitate the transport and storage of additional materials required in the painting, cleaning, drywall, and coatings profession. Examples of said materials could be cleaning materials, drywall compound or materials, or other compounds, liquids, powders, solids, and gases.

Another object of the present invention is to integrate a means to prevent coating material or paint or other material from dripping, spilling, or splattering onto the carpet, floor or table where the invention is placed while work is being performed. The invention also transports, stores, and provides workers with the paint or coating material itself.

The design of the unfolding splatter guard, serving as an external cover for the box when closed, encourages cleanliness on the workers' part, which represents an additional object of the invention. When a worker is given a large tarp to cover the work area, the worker is naturally less careful. Yet one more object of the present invention is prevention of stepping in and tracking wet paint from the tarp. The folding spatter guard area is small enough that workers need not walk across it during use. Among other things, dripping paint and stepping in it, causing it to be tracked across the floor area is a consequence of a larger, separate protective cover being used in the work area. With the limited space provided by the integrated unfolding splatter guard of the present invention, workers tend to behave much more carefully, cannot track paint spills elsewhere, and the invention thus ensures that all paint splatter and drips are kept on the splatter guards or in the paint vessel.

Finally, an object of the present invention includes being sized to fit in nearly any room when its splatter guard is unfolded, reflecting another advantage of the smaller, integrated unfolding splatter guard, which, of course, serves as a box covering and mechanical attachment point for carrying handles when closed. Of course, as is common with large boxes, wheels may be attached, thus permitting users to pull the tool and storage device across a surface rather than carry it. The addition of wheels or wheel sets or other friction reducing solutions like Teflon or smooth pads or skids would be optional.

In sum, the present invention addresses the practical needs of painting, cleaning, treating, or coating application contractors and workers who specialize in small, high-volume jobs, which demand frequent changes of work location. Examples include apartment painting or office painting or cleaning, where reducing setup and teardown time is crucial. None of the prior inventions offer the needed solutions to organize, store, and transport wet painting tools and other necessary tools. The invention aims to optimize the setup and teardown of a painting job by combining the tarp, paint vessel, and toolbox into one convenient apparatus.

### BRIEF DESCRIPTION OF THE SEVERAL VIEWS OF THE DRAWINGS

FIG. 1 is an embodiment of the present invention without tools or material containers in place but fully opened, as it would lay flat on a floor or table.

FIG. 2 is an embodiment of the present invention without tools or material containers in place but closed and ready for a worker to carry the invention to a worksite.

FIG. 3 is an embodiment of the present invention with paint containers, including the material containers, in this example a roller well and trim cups, added and in place. This figure shows the invention partially opened, such that continuing to unfold the top and sides would result in the configuration depicted in FIG. 1 except that containers capable of holding paint or other materials are now installed.

### DETAILED DESCRIPTION OF THE INVENTION

The present invention is a device that is at least one material vessel, tool holder, and protective splatter guard, or any novel combination of the three to yield labor saving and splatter protection benefits beyond the benefits derived by using paint containers, tool boxes and tarps separately. The device may be comprised of wood, plastic, metal, or any other solid material providing sufficient structural support to hold tools and liquids. The sides of the device may be comprised of foam, wood, plastic, PVC, metal, fabric, or any combination of these materials that serve the dual function of enclosing the device and protecting a surface from paint splatter by stopping the propagation of spilled paint to the lower surface in contact with the floor, carpet, or table. In a preferred embodiment of the present invention, the sides of the device may be covered with an absorbent material such as painter's drop cloth or tarp material. In a preferred embodiment of the present invention the folding splatter guard is lightweight, semi-rigid, and somewhat pliable.

The inventive device may have holes in it that serve the function of holding additional tools, or material vessels. For example, vertical holders may be included to hold paint roller handles with the roller positioned upright, above the tarp, and generally clear from becoming a tripping hazard or inadvertent source of contact with wet paint. Built-in tool holders and material vessels may also exist, and these may or may not be removable for use at the work site, or a combination of both features depending upon which tool or material holder is utilized. In a preferred embodiment of the present invention, a roller bucket may be left positioned in the inventive device without being removed while smaller trim cups may be removed and held by the painters who do trim or brush work, and later returned to the device when the work is completed and it is time to move to a new worksite.

An integrated tool box to hold the necessary combination of hand tools required for the workers is a desirable element in the present invention; for example, to store and transport screwdrivers, hammers, stirring tools, rags, other chemicals, and so forth. In a preferred embodiment of the invention, this toolbox is underneath a top surface to prevent paint or other materials from dripping into the toolbox while being tilted at a convenient angle in order to enable easy access by workers.

A means for securing the folding splatter guard or segmented splatter guard in its closed position may be a feature of the device. Such means of securing guards in a given position are universally known by people skilled in various arts, including the painting profession, and may be detachable or permanent. The device may implement magnets, Velcro, snaps, buttons, or another type of fastener to perform this function, or attachment may be accomplished simply through use of the designed interference between two objects, such as fabric or other material stretched over itself or perhaps crossing over a rigid surface, which would not come loose until stretched and pulled free again.

A means for keeping the splatter guard closed during transport and storage is also an object of preferred embodiments of the present invention. In a preferred embodiment of the current invention, magnets are used to hold the sides to the device up with the top of the splatter guard closed and across the top of the structure. Magnets are one solution selected in order to maintain their function if paint were to cover or clog a more commonly found type of fastener.

A plurality of handles on the exterior of the device may exist to facilitate transport. These handles may be composed of fabric, plastic, wood, metal, or any other material strong enough to support the device. In the preferred embodiment of the current invention, nylon handles are used, allowing the sides to lay flat when functioning as splatter guards.

Several additional features are envisioned to enable the invention to be used in specific work settings or environments, which benefit from these features. An embodiment of the invention may include electrical service outlets integrated into the carrier, or an embodiment may include a variety of lighting types, including those supplied by a power outlet or electrical hookup or those supplied by incorporation of a battery source of electrical power. These inventive combinations and others are considered part of the invention.

An embodiment of the invention may include a radio, stereo, television receiver, or even a video or display screen to provide entertainment for workers performing the repetitive tasks required. Another embodiment of the invention may include communications devices or a means to store a communication device such as a two-way radio, cell phone, smart phone, mobile computing device, or pad type computing device. Yet another embodiment may include a storage and carrying means for paperwork, instructions, or record keeping. In the alternative to paperwork, electronic storage means for records may be included.

It is understood that the envisioned invention, its structural elements and suggested materials are not intended to be limited by those suggested or claimed choices preferred for certain embodiments, nor are the various means of attachment or assembly which are nearly universally known across many fields of art and therefore need not burden to the reasonable specification economy of the present invention. To these points, the splatter guard's outer, paint or material protective coverings or coatings may be made of nearly any non-porous material or, in an alternative, sufficiently absorbent material to serve the purpose as a means to protect the supporting surface from paint spills, drips, or splattering. Material to form the structure of the invention may be produced using any material sufficiently rigid to mechanically hold the containers or tools, and one or more of material containers may be integrated into the device itself as an integrated unit, for example, using vacuum forming or injection molding of the entire structure. In all cases of storage or material containers or material container holders the inventor intends the quantity to be one or more if the embodiment of the invention comprises that element. Latching or attachment or mechanical disconnection means shall not be limited to any particular locking, attachment, latching, or connective means except that such means shall be sufficient to keep the sidewall from falling back down on its own after it has been fixed using such means. Similarly, the various means for attaching the splatter guard to the structure may be fixed or removable and selected from snaps, threaded fasteners, adhesive, tape, straps, magnets, sewn, riveted, any other forms of mechanical interlocking or interferences, or from nearly all of the other well-known methods for connecting mechanical objects without limitation as long as such means does not compromise the function of the splatter guard. Likewise, carrying handles incorporated into any embodiment, when desired, may be any carrying handle type known in the art as long as it is sufficiently strong and adequately attached to support the loads of the present invention and its contents.

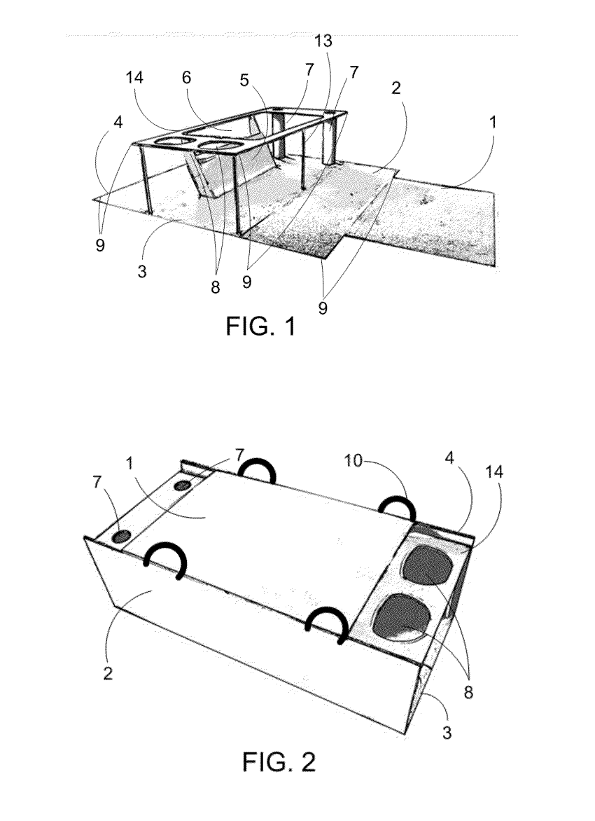

FIG. 1

The embodiment of the invention depicted in FIG. 1 includes an attached splatter guard (4) in its unfolded position and comprised of a top cover (1) made of material, such material being capable of protecting the underlying surface from paint drips or other material splatter, and which is flexibly connected to a sidewall (2), also shown in an unfolded position and made of similar, protective material. The splatter guard (4) including its sidewall (2) are flexibly connected to a bottom surface (3) and made of material capable of protecting the underlying surface from paint drips or other material spills or drips.

A toolbox (5) is affixed to the bottom surface (3) and top of the structure (14), which has cutouts to accommodate tool holders (7) or paint or material containers (8) such as trim cups or both. In the embodiment shown here, vertical supports (13), rather than sides, provide depth to the structure (14). A larger cutout (6) serves to accommodate a larger paint vessel or material container (not shown in this figure), wherein said vessel or container may be left in place during use, removable for use, or, in another embodiment, may be integrated into the device (also not shown). The vertical tool holders (7) are sufficiently deep to hold a roller handle in a generally vertical position, not leaning over by more than 45 degrees of the normal to the plane of the structure (14) top, or, if the worker elected to do so, hold a brush in a similar generally vertical position or any other tool such as an extension pole, measuring stick, and so forth. Open areas to hold or support containers (6), (8) may be sized for trim cups or larger containers such as roller wells, buckers, or pans.

When the invention is to have the splatter guard (4) folded closed and ready for carrying or storage, such that a top cover (1) sits atop the top surface of the structure (not shown in this position—see FIG. 2), the splatter guard (4) may be held using a fixation mechanism (9), such as a magnetic latch as is the case in a preferred embodiment. If a magnetic latch system is used then a magnet and magnetically responsive material such as another magnet or magnetic metal must be affixed to the top piece and near the top of the sidewalls (2). This example presented, it should be noted that any separable and reattachable mechanical connection known in the past, present, or forward art can serve this function.

FIG. 2

The present invention with the splatter guard (4) positioned in its fully folded and closed position is shown in FIG. 2. Likewise, this embodiment of the present invention includes an structure (14) with openings intended to hold paint or material containers (8) such as trim cups which typically have wet brushes inside are also left open above a top cover (1) without mechanical interference from the top cover (1) when in a closed position.

The integrated spatter guard includes a top cover (1), which protects the underlying material container (not visible) from contamination, evaporation, or slopping out excessively. A sidewall (2) is now vertical. This sidewall (2) being attached to the top cover (1) and the other edge of said sidewall (2) being attached to the splatter guard (4) where it passes under the structure (14). Said top cover (1) does not interfere with the area directly above the vertical tool holders (7) to permit long tools such as roller extension handles to be carried in the invention while the top cover (1) is closed.

Carrying handles (10) are shown to permit one or even two or more workers to easily transport the invention, with paint, paint containers, and tools, to a vehicle or another worksite. In this embodiment, the carrying handles are attached to the splatter guard (4) using any means commonly known in the art, such as sewing, rivets, or other common method of mechanical connection.

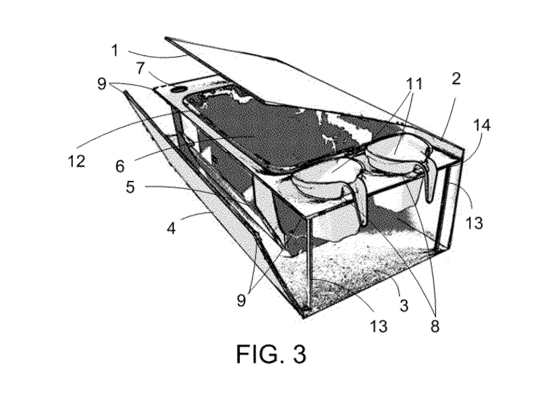

FIG. 3

This Figure illustrates an embodiment of the present invention with the top cover (1) partially raised and splatter guard (4) partially lowered after disconnecting the fixations mechanism (9), which is comprised of a pair of magnets in this particular embodiment. The toolbox (5) does not contain tools in this illustration, but is intended for screwdrivers, hammers, tape measures, scraper, brushes, sponges, and other useful tools. The large cutout (6) in the structure (14) accommodates a deep paint roller tub (12). Two smaller openings for paint vessels or material containers (8) are shown holding typical commercial trim cups (11). Vertical supports (13) are shown as part of the structure (14) at its end area located near the openings for the trip cups (8). In another embodiment, sides may be used instead of vertical supports (not shown). At the opposite end, the top opening of a vertical tool holder (7) is shown.

What is claimed is:

1. A transport and storage device for one or more tools and one or more materials, comprising:
a structure having a top, bottom, and one selected from the group consisting of sides and vertical supports;
tool holders attached to said structure and capable of holding tools vertically;
a toolbox attached to said structure;
one or more holes in the top of said structure, said holes being able to receive one or more vessels or containers, said vessels or containers being capable of containing materials or additional tools; and,
a splatter guard affixed to said structure, said splatter guard having a closed position to provide at least a partial enclosure for said transport and storage device and an open position to protect the surface beneath said open splatter guard.

2. The transport and storage device according to claim 1 wherein said transport and storage device has a fixation mechanism for securing said splatter guard in its closed position.

3. The transport and storage device according to claim 1 wherein said transport and storage device has one or more handles.

4. The transport and storage device according to claim 1 wherein said holes in the top of said structure and vessels and containers are one in the same.

5. The transport and storage device according to claim 1 wherein said vertical tool holders are tubular.

6. The transport and storage device according to claim 1 wherein said vertical tool holders allow tools held in said vertical tool holders to rest at an angle up to 45 degrees off of a normal to the plane of the top of said structure.

7. The transport and storage device according to claim 1 wherein said integrated toolbox is mounted between top and bottom of said structure.

8. The transport and storage device according to claim 1 wherein attachment points for said splatter guard allow for removal or replacement of said splatter guard.

9. The transport and storage device according to claim 1 wherein said splatter guard is comprised from one or more separate sections of splatter guard material, one or more of which is movable and detachable from said structure.

10. The transport and storage device according to claim 2 wherein a fixation mechanism for securing said external cover in it's closed position is comprised of one or more selected from the group consisting of magnets, snaps, Velcro, locks, buttons, screws, nails, tacks, adhesive, threaded fasteners, turnkey fasteners, locks, or hooks.

11. The transport and storage device according to claim 1 wherein said transport and storage device additionally is comprised of one or more electrical outlets providing a power source as needed.

12. The transport and storage device according to claim 11 wherein said electrical outlets are powered by one selected from the group consisting of a generator, battery, and an extension cord capable of reaching another electrical outlet.

13. The transport and storage device according to claim 1 wherein said transport and storage device additionally is comprised of one or more selected from the group consisting of a radio, TV, stereo, mp3 player, 2-way communication device, a computing device, phone, tablet computer, and laptop computer.

14. The transport and storage device according to claim 1 wherein said transport and storage device additionally is comprised of a storage device for paperwork.

15. The transport and storage device according to claim 1 wherein said transport and storage device additionally is comprised of a storage device for electronic records.

16. A transport and storage device with a folding splatter guard comprised of
a box with openings to receive one or more material or one or more tool containers; and,
attachment points for affixing said splatter guard to said box.

17. The transport and storage device according to claim 16 wherein said box has one or more open sides.

18. The transport and storage device according to claim 16 wherein said folding splatter guard is partially or entirely removable.

19. A transport and storage device comprised of
a splatter guard of leak proof material surrounding a rigid structure comprised of a top and bottom wherein said splatter guard may be unfolded to a generally flat position; and,
openings in said structure to receive containers.

20. The transport and storage device according to claim 19 wherein said structure contains a toolbox.
